(19) United States
(12) Patent Application Publication
(10) Pub. No.: US 2012/0236601 A1
(43) Pub. Date: Sep. 20, 2012

(54) ELECTRONIC DEVICE

(75) Inventor: Koji NAKAKUBO, Kawasaki (JP)

(73) Assignee: FUJITSU LIMITED, Kawasaki-shi (JP)

(21) Appl. No.: 13/418,429

(22) Filed: Mar. 13, 2012

(30) Foreign Application Priority Data
Mar. 15, 2011 (JP) 2011-057291

(51) Int. Cl. F21V 8/00

(52) U.S. Cl. 362/634

(57) ABSTRACT

There is provided an electronic device which includes a case configured to include a light emitting portion, a light source configured to emit light in the case, a light guide member configured to include a light guide plate for guiding the light from the light source to the light emitting portion and to include a holder for fixing the light guide plate, and a substrate configured to fix the light guide member. The holder has a light blocking property. The light guided with the light guide plate is emitted outside the electronic device through the light emitting portion.

### CROSS-REFERENCE TO RELATED APPLICATION

This application is based upon and claims the benefit of priority of the prior Japanese Patent Application No. 2011-057291, filed on Mar. 15, 2011, the entire contents of which are incorporated herein by reference.

### FIELD

The embodiments discussed herein are related to an electronic device.

### BACKGROUND

In the related art, in an electronic device, a design is provided in which a part of a case is lit up. For example, there is an electronic device which is designed such that a part of a case made of a translucent material is shaded by a light-blocking masking portion, thus light of a light emitting diode (LED) provided within the case is applied to the outside of the case through a portion of the case which is not masked.

Japanese Laid-open Patent Publication No. 2008-185604 is an example of the related art.

### SUMMARY

According to an aspect of the invention, an electronic device includes a case configured to include a light emitting portion, a light source configured to emit light in the case, a light guide member configured to include a light guide plate for guiding the light from the light source to the light emitting portion and to include a holder for fixing the light guide plate, the holder having a light blocking property, and a substrate configured to fix the light guide member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating an electronic device according to a first and second embodiments.

FIG. 2 is a relevant portion cross-sectional view taken along the cutting plane line A-A′ in FIG. 1.

FIG. 3 is a perspective view illustrating a light guide member of the electronic device according to the embodiments.

FIG. 4 is a perspective view illustrating a light guide plate holder of the electronic device according to the embodiments.

FIG. 5 is an exploded perspective view illustrating a case of the electronic device according to the second embodiment.

FIG. 6 is a front view illustrating a state where the light guide member of the electronic device according to the second embodiment is removed.

FIG. 7 is a front view illustrating a state where the light guide member of the electronic device according to the second embodiment is mounted.

### DESCRIPTION OF EMBODIMENTS

### Preliminary Consideration

However, in an existing electronic device, when a plurality of openings are provided to a case, it is difficult to uniformly apply light of one LED through the plurality of openings, which are portions not masked. In order to uniformly apply light through a plurality of openings, it is considered that a light guide plate which guides light is provided between an LED and the plurality of openings. Accordingly, the light of the LED is guided to the plurality of openings via the light guide plate. However, in order to provide such a light guide plate, a member for fixing the light guide plate is needed. In addition, in order to prevent light incident on the light guide plate from leaking through a portion other than the openings, a light-blocking member for covering the portion of the light guide plate other than the openings is also needed. The existing electronic device has the problems described above.

Hereinafter, preferred embodiments of an electronic device will be described with reference to the accompanying drawings. The electronic device includes a light guide member including: a light guide plate which guides light from a light source; and a light guide plate holder for fixing the light guide plate. In the following description of each embodiment, the same components are designated by the same reference characters, and the overlap description is omitted.

### First Embodiment

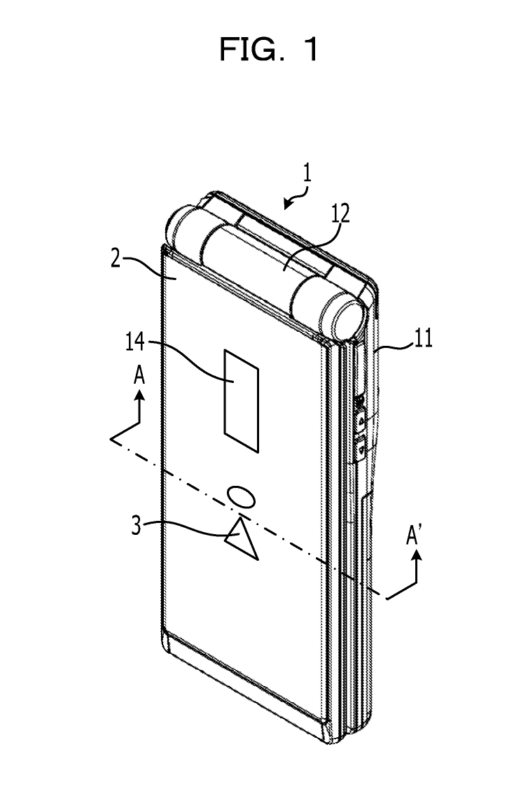

FIG. 1 is a perspective view of an electronic device according to the first embodiment. As illustrated in FIG. 1, the electronic device 1 includes a case 2. In the case 2, a light-emitting portion 3 is provided.

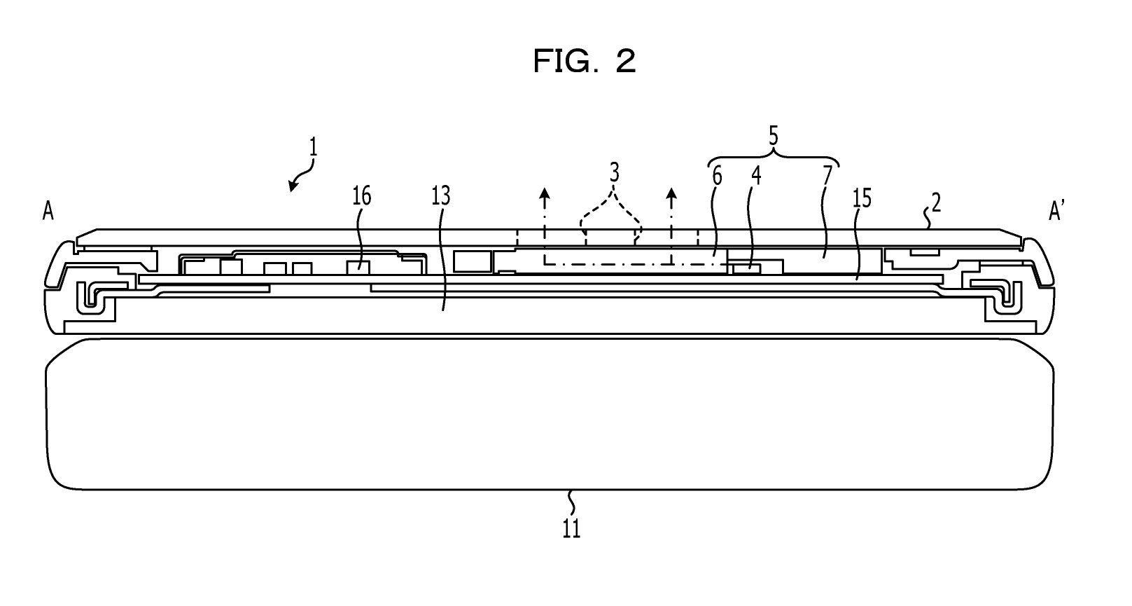

FIG. 2 is a relevant portion cross-sectional view taken along the cutting plane line A-A′ in FIG. 1. As illustrated in FIG. 2, in the case 2, a light source 4 is included. The light source 4 emits light in the case 2. In addition, in the case 2, a light guide member 5 is provided. The light guide member 5 includes a light guide plate 6 and a light guide plate holder 7. The light guide plate 6 guides the light emitted by the light source 4. The light guide plate 6 is located in a position corresponding to the light-emitting portion 3 of the case 2. The light emitted by the light source 4 passes through the light guide plate 6 and exits to the outside of the case 2 through the light-emitting portion 3 of the case 2, as indicated by an arrow of an alternate long and short dash line.

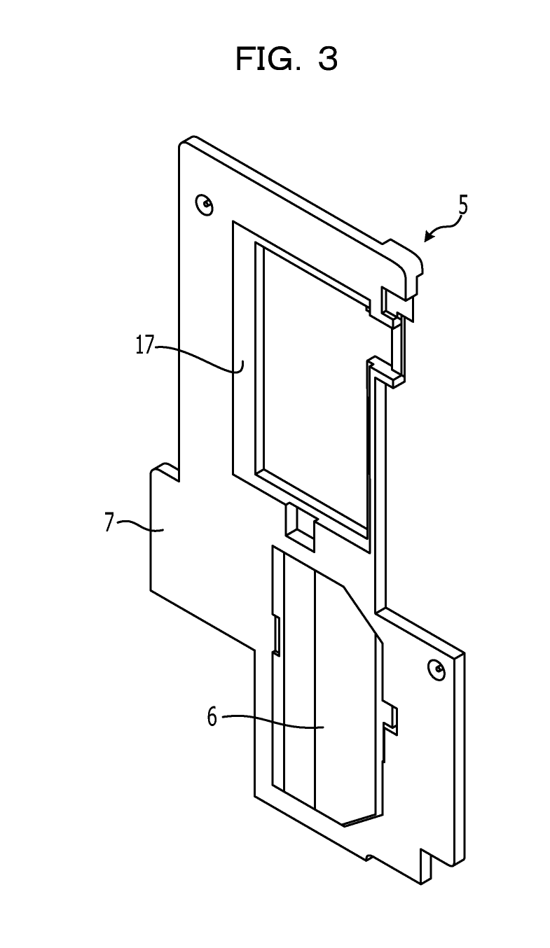

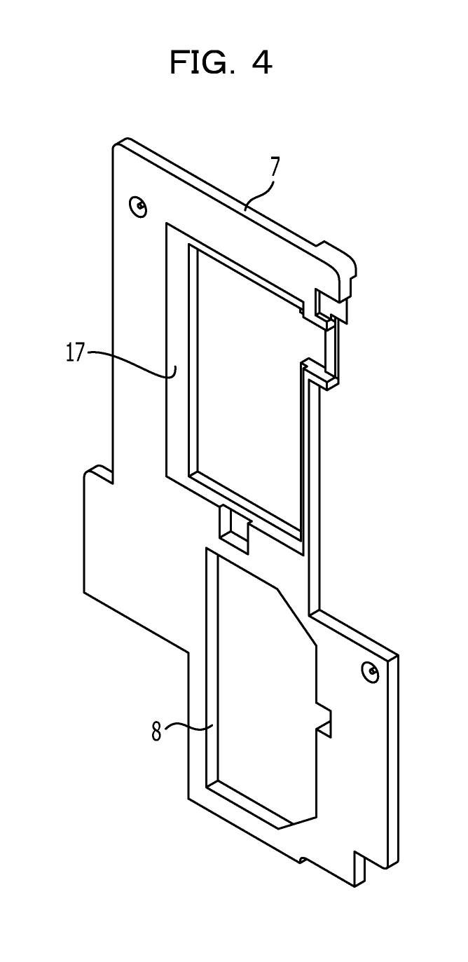

FIG. 3 is a perspective view illustrating the light guide member of the electronic device according to the embodiment. FIG. 4 is a perspective view illustrating the light guide plate holder 7 of the electronic device 1 according to the embodiment. FIG. 3 illustrates a state where the light guide plate 6 is mounted to the light guide plate holder 7. As illustrated in FIGS. 3 and 4, in the light guide plate holder 7, an opening 8 for fixing a light guide plate 6 is provided. The light guide plate 6 is fixed to the light guide plate holder 7 by being fitted into the opening 8. By the light guide plate 6 being fixed to the light guide plate holder 7, a light guide path which guides the light from the light source 4 to the light-emitting portion 3 of the case 2 is provided in the light guide member 5. The light guide plate holder 7 has a light-blocking effect.

According to the first embodiment, since the light guide plate 6 is fixed to the light guide plate holder 7, the light guide plate 6 may be fixed to the case 2 by fixing, to the case 2, the light guide member 5 without use of a member for fixing the light guide plate 6 to the case 2. Therefore, a member for fixing the light guide plate 6 to the case 2 may be omitted. Size increase of the case may be prevented because it is unnecessary to independently provide members for fixing the light guide plate to the case and for preventing leak of light from the light guide plate.

### Second Embodiment

An example of the electronic device is, for example, a mobile phone. In the second embodiment, the mobile phone as the electronic device 1 is, for example, a folding type mobile phone as illustrated in FIGS. 1 and 2, but not limited to it.

The case 2 is mounted to a phone body 11 via a hinge portion 12 so as to be openable and closable. In a back surface of the case 2 which faces the phone body 11 when folded, a main display panel 13 is provided as illustrated in FIG. 2. In a front surface of the case 2, the light-emitting portion 3 and a sub display panel 14 are provided.

On the main display panel 13 and the sub display panel 14, letters and designs (pictures) are displayed. In the phone body 11, keys for inputting letters, numbers, symbols, and the like may be provided. Alternatively, the main display panel 13 may be a touch panel, and letters, numbers, symbols, and the like may be inputted by a user touching the touch panel. FIG. 2 illustrates relevant part portion of the cross section of the phone body 11, while the detailed configuration is omitted. In FIG. 2, the light source 4 and an electronic component 16 are mounted to the substrate 15 to which the light guide member 5 is fixed. An example of the light source 4 is, for example, an LED.

As illustrated in FIGS. 3 and 4, in the light guide plate holder 7, the opening 8 for fixing the light guide plate 6 and an opening 17 for fitting a sub display panel are provided. The light guide plate 6 is fitted into the opening 8. The sub display panel 14 is mounted to the substrate 15 in a state of being fitted into the opening 17. In other words, the light guide plate holder 7 serves as a member for mounting the sub display panel 14.

The light guide plate 6 is made of a light transmissive material. Examples of the light transmissive material are resin and glass. The color of the light guide plate 6 may be any color as long as it allows light to pass therethrough, but the light guide plate 6 may be, for example, colorless and transparent. The portion of the light guide plate 6 corresponding to the light-emitting portion 3 of the case 2 may be, for example, embossed. The light is scattered thereby and thus the light-emitting portion 3 may be lit up brighter when light having passed through the light guide plate 6 exits from the light guide plate 6. The light guide plate holder 7 may be made of, for example, resin.

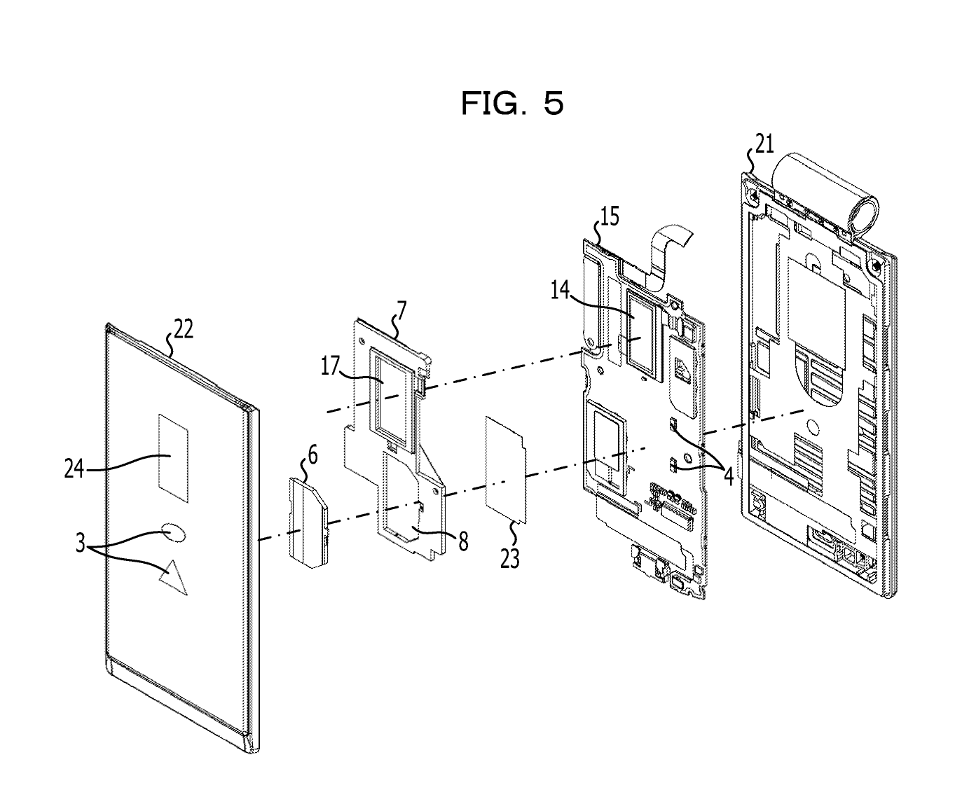

FIG. 5 is an exploded perspective view illustrating the case of the electronic device according to the embodiment. As illustrated in FIG. 5, the case 2 includes a case body 21 and an exterior panel 22 which are joined to each other. In the exterior panel 22, a display window 24 for the sub display panel, and the light-emitting portion 3 are provided. Although not appearing in FIG. 5, the main display panel is provided in the case body 21. The substrate 15, a reflection sheet 23, the light guide plate holder 7, and the light guide plate 6 are enclosed between the case body 21 and the exterior panel 22.

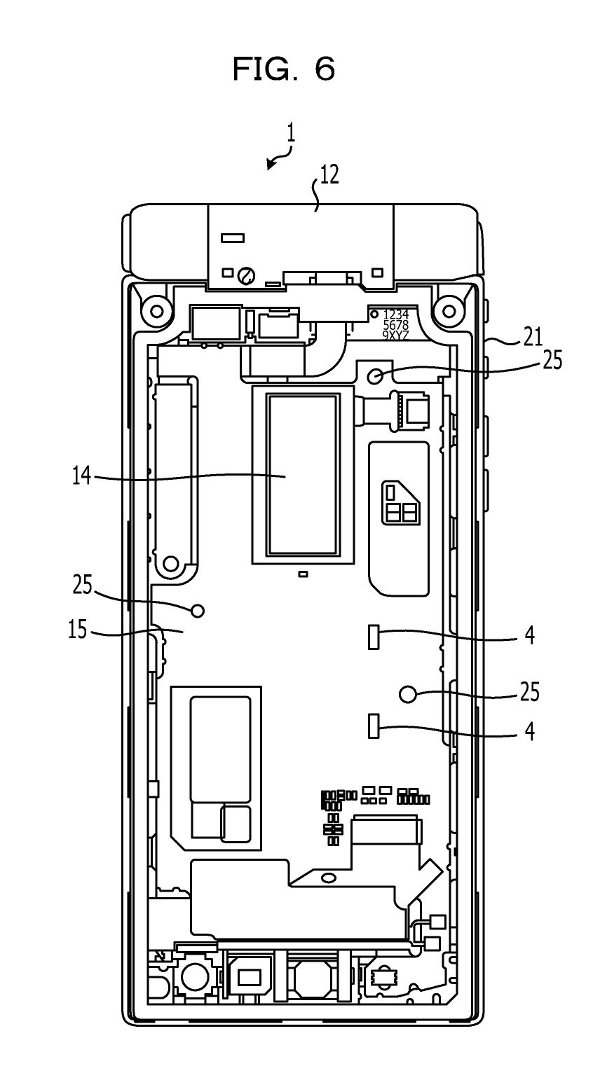

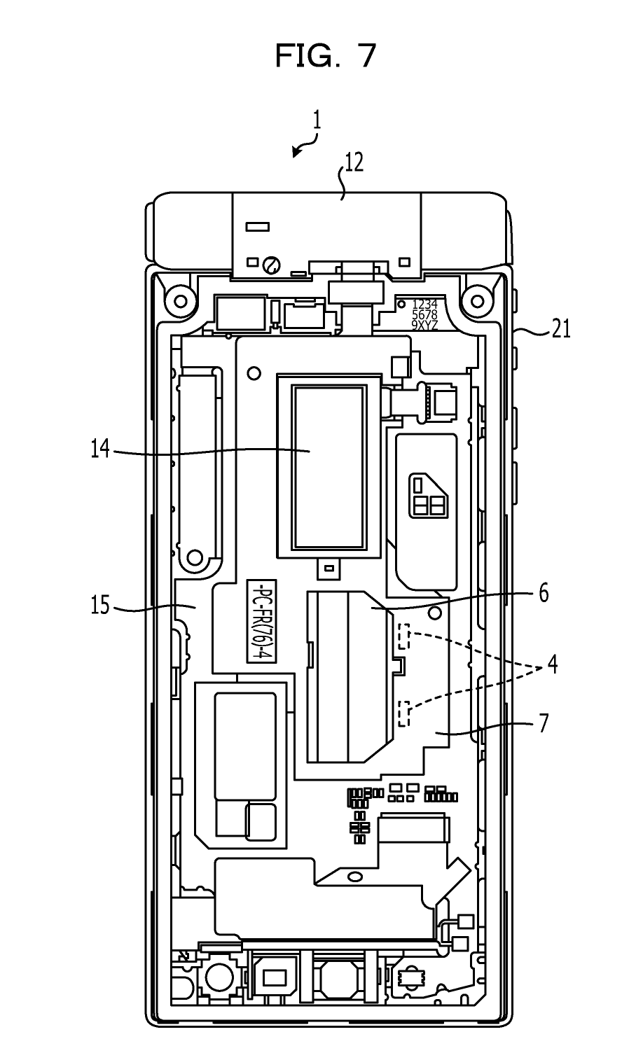

FIG. 6 is a front view illustrating a state where the light guide member 6 of the electronic device 1 according to the embodiment is removed. FIG. 7 is a front view illustrating a state where the light guide member 6 of the electronic device 1 according to the embodiment is mounted. As illustrated in FIGS. 2 and 5 to 7, the light source 4 is located so as to face a side of the light guide plate 6. The light source 4 is located below the light guide plate holder 7. The sides of the light source 4 other than the side facing the light guide plate 6 are surrounded by the light guide plate holder 7.

The light guide plate holder 7 may have a light-blocking effect. For example, the light guide plate holder 7 may be made of a material that is not transparent, or may be colored in such a color as to prevent light from passing therethrough. Accordingly, the light of the light source 4 is blocked by the light guide plate holder 7, and thus may be prevented from leaking to the surrounding.

Further, the light guide plate holder 7 may have light reflective performance. For example, the light guide plate holder 7 may be made of a material having a high light reflectivity, or may be colored in such a color that the light reflectivity thereof increases. An example of such a color that the light reflectivity increases is white. Accordingly, the light emitted by the light source 4 which travels not toward the light guide plate 6 but toward the light guide plate holder 7 is reflected by the light guide plate holder 7 and incident on the light guide plate 6. In addition, light that is incident on the light guide plate 6 and passes through the light guide plate 6 to reach the light guide plate holder 7 is reflected by the light guide plate holder 7 and incident on the light guide plate 6 again.

Obtaining both of a light-blocking effect and light reflection performance, for example, the light guide plate holder 7 may be made of a white material that is not transparent or may be colored in white that is not transparent.

Although not appearing in each drawing, a portion of the light guide plate holder 7 which comes into contact with the substrate 15 may be provided with, for example, a plurality of projections for fixing the light guide plate holder 7 to the substrate 15. Meanwhile, as illustrated in FIG. 6, a portion of the substrate 15 which comes into contact with the light guide plate holder 7 is provided with a recess or hole 25 for fixing the light guide plate holder 7. The recess or hole 25 of the substrate 15 for mounting the light guide plate holder 7 is provided in a position corresponding to the plurality of projections of the light guide plate holder 7. The light guide plate holder 7 is mounted in a proper position on the substrate 15 by inserting the projections of the light guide plate holder 7 into the recess or hole 25 of the substrate 15.

With reference to FIG. 5, a procedure for assembling the case 2 will be described. First, the light guide plate 6 is fixed into the opening 8. In addition, the reflection sheet 23 is attached to the back surface of the light guide plate 6 in the light guide plate holder 7. The light guide member 5 includes the light guide plate 6 and the light guide plate holder 7 which are fixed to each other. Next, the light guide member 5 is mounted to the substrate 15. The light guide plate holder 7 may be fixed to the substrate 15 by using an adhesive or a two-sided adhesive tape.

Next, the sub display panel 14 is mounted to the substrate 15 such that the sub display panel 14 is fitted into the opening 17 of the light guide plate holder 7. The sub display panel 14 is fixed in a proper position by fitting the sub display panel 14 into the opening 17.

Next, the substrate 15 is mounted to the case body 21. Then, the exterior panel 22 is mounted to the case body 21, whereby the case 2 is completed. It should be noted that after the substrate 15 is mounted to the case body 21, the light guide member 5 and the sub display panel 14 may be mounted to the substrate 15.

According to the second embodiment, the same improvement as those in the first embodiment may be achieved. In addition, when the light guide plate holder 7 has a light-blocking effect, the light of the light source 4 does not leak to the surrounding. Thus, it is not necessary to provide light-blocking masking to the case 2. Further, when the light guide plate holder 7 has light reflection performance, the amount of light incident on the light guide plate 6 increases. Accordingly, the light-emitting portion 3 of the case 2 may be lit up brighter. Moreover, by changing the exterior panel 22 with another one which includes the light emitting portion 3 different from that of the exterior panel 22, a mobile phone in which the shape of the light-emitting portion 3 is different may be obtained.

It should be noted that the electronic device is not limited to the mobile phone, but may be any device as long as a light-emitting portion of a case is lit up by light of a light source within the case, for example, an electronic calculator such as a personal computer, a portable audio recording/reproducing device, home appliance such as a television receiver, or a toy such as a game device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An electronic device comprising:
a case configured to include a light emitting portion;
a light source configured to emit light in the case;
a light guide member configured to include a light guide plate for guiding the light from the light source to the light emitting portion and to include a holder for fixing the light guide plate, the holder having a light blocking property; and
a substrate configured to fix the light guide member.

2. The electronic device according to claim 1, wherein the guided light is emitted outside the electronic device through the light emitting portion.

3. The electronic device according to claim 1, wherein the holder includes a reflective portion which reflects the emitted light.

4. The electronic device according to claim 3, wherein the reflective portion reflects a part of the emitted light toward the light guide plate.

5. The electronic device according to claim 1, further comprising a display panel, the display panel being fixed to the holder.

6. The electronic device according to claim 1, wherein the light source is mounted on the substrate so as to be disposed between the substrate and the holder, the light source being opposed to the light guide plate.
